(19) United States
(12) Patent Application Publication
(10) Pub. No.: US 2014/0312177 A1
(43) Pub. Date: Oct. 23, 2014

(54) Coaxial rotor/wing aircraft

(71) Applicant: Rajesh Gaonjur, Montreal (CA)

(72) Inventor: Rajesh Gaonjur, Montreal (CA)

(21) Appl. No.: 13/986,274

(22) Filed: Apr. 18, 2013

(51) Int. Cl. B64C 27/24

(52) U.S. Cl. CPC B64C 27/24
USPC 244/7 A

(57) ABSTRACT

A system and method which enable efficient, rapid and safe transition between rotary-wing and fixed-wing flight mode in rotor/wings aircrafts is disclosed. The aircraft comprises of two rotor/wings on the same axis of rotation, one above the fuselage and the other one under the fuselage. During rotary-wing mode, the rotor/wings rotate coaxially and provide vertical lift. During transition between rotary-wing and fixed-wing modes, the synchronised operation of the two rotor/wings maintains lateral symmetry of lift on the aircraft. The reaction of the rotor/wings on the fuselage is also canceled. During fixed-wing flight mode, the two rotor/wings are stopped and locked in a biplane configuration, both providing lift as fixed wings. The rotor/wings may be further reconfigured for higher subsonic or supersonic speed. Tandem and multiple rotor/wings aircrafts with increased cargo capacity, speed and range, comprise of multiple of these coaxial rotor/wings.

### FIELD OF THE INVENTION

The invention relates to a type of vertical take-off and landing aircraft generally referred as rotor/wing or stop-rotor aircraft.

### BACKGROUND

One of the most promising vertical take-off and landing aircrafts (VTOL) is known in as the stop-rotor or the rotor/wing aircraft. The concept behind this type of aircraft is using a set of wings selectively in a rotary-wing mode or in a fixed-wing mode, in order to produce vertical lift. In the rotary-wing mode, the rotor/wing rotates in a horizontal plane to produce vertical lift similar to a helicopter. In the fixed-wing mode, the rotation of the rotor/wing is stopped and positioned traverse to the fuselage, in order to produce vertical lift similar to the fixed wings of an airplane.

The rotor/wing aircrafts have many advantages over other concepts of VTOL aircrafts such as, compound-helicopters, tilt-rotor aircrafts, and even unpowered rotary-wings aircrafts commonly known as gyroplanes. The wingspan of the rotor/wing provides the equivalent of a rotor having a large diameter when operating in a powered rotary mode. This enables vertical take-off, vertical landing and hover with a low disc loading comparable to helicopters, thus requiring less power than tilt-rotor aircrafts and airplanes which have rotors of smaller diameter incorporated inside their fixed-wings. The ability to stop the rotation of the rotor/wing and use alternative more efficient propulsion systems for horizontal flight enable rotor/wing aircrafts to exceed the speed limitation of helicopters and achieve efficient high speed flight comparable to airplanes. This concept enables considerable down-sizing, cost reduction and efficiency in the design of VTOL aircrafts and is desirable for many applications ranging from micro aerial vehicles, unmanned drones, and a wide variety of manned vehicles for military, commercial and general aviation. However rotor/wing aircraft remains a field of research. So far, no practical and reliable rotor/wings aircraft is known to exist till date.

The main problem in implementing the rotor/wing concept lies in the difficulty to achieve transition between the rotary-wing and the fixed-wing mode. As the rotor/wing is slowed down to a stop, it becomes seriously affected by the dissymmetry of lift caused by the advancing portion and retreating portion of the rotor/Wing. At some point during transition, the retreating potion operates entirely in the reverse flow region. The aircraft experiences complete loss of lift on the retreating side of the rotor/wings. The aircraft is subjected to dangerous pitching, rolling movements and loss of altitude, with serious consequences. Reduction of the duration of the transition is often though of as a way to overcome the problem.

However, it is physically not possible to reduce the transition time beyond certain point. Rotor/wings have increased dimension, weight, and rotational inertia, and they store significant amount of energy while in the rotary-wing mode. In accordance with the action reaction principle, and conservation laws of energy and momentum, the transition between rotary-wing and fixed-wing mode induces destabilizing reaction forces on the fuselage of the aircraft. The strength of this reaction force is inversely proportional to the duration of the transition, and the duration of the transition hence dependents on the ability of the vertical tail stabilisers to compensate for the sudden and high reaction force acting on the fuselage. The vertical stabiliser would need to be excessively out of proportion to compensate the large reaction force and is not practical due to extra weigh and drag penalty. In several prior disclosures the rotor/wing is allowed to rotate in autorotation for some length of time until it decays to an acceptable level, before it can be stopped and locked in position. During the prologue transition, the aircraft is vulnerable as it continues to experience unbalance lateral lift.

The combination of these two forces makes transition between rotary-wing and fixed-wing mode a critical and lengthy operation which most prior arts have remained incapable of dealing effectively. These problems are addressed mostly by having additional auxiliary fixed wings in order to assist the transition. Sometime, rotor/wings with more than 2 blades are proposed in order to reduce the lateral asymmetry of lift. But these auxiliary wings and extra blades erode many of the advantages of the aircraft in both flight modes, in the form of weigh penalty, increased aerodynamic drag and complexity. The operation requires complex coordination of control surfaces on the auxiliary wings and vertical stabiliser, which are generally operated by sophisticated automated system in order to compensate the destabilizing forces. For example in U.S. Pat. No. 3,327,969 the rotor/wing consisted of three blades and included an auxiliary wing in the form of an oversized lifting hub. In U.S. Pat. No. 5,454,530 a canard wing and a lifting tail was proposed to compensate for the drop and lateral asymmetry of lift during transition. The invention was implemented in the Boeing X-50 dragonfly, but experimentation was discontinued as the invention failed to give the expected result. In U.S. Pat. No. 6,789,764 B2 and U.S. Pat. No. 7,334,755 B2, the disclosed aircrafts which consisted of tandem rotor/wings also relied heavily on auxiliary fixed wings to assist transition between flight modes.

A rotor/wing concept was disclosed in U.S. Pat. No. 8,070,090, accordingly to which, the wings were made to flip in the direction of the wind to prevent the condition of reverse flow during transition. The invention also proposed to reduce the disturbance and deviation in flight path during transition by making conversion between the two flight modes by quickly stopping/or starting the rotation of the rotor/wing within 2 seconds and less. The method, by which the reaction force on the fuselage is countered, is not clearly commented. The invention was directed principally for unmanned aircrafts. Application of this concept in larger manned aircrafts may be complicated due to possible difficulty to flip larger and heavier set of wings.

In U.S. Pat. No. 7,665,688 B2 an aircraft was disclosed with a different concept of rotor/wing which maintained lateral symmetry of lift during transition, thus enabling reliable transition between the two flight modes. However this is achieved by an increase in complexity, as this arrangement requires a second vertical rotor system, consisting of two counter-rotating rotors with titling mechanisms and a set of additional fixed wings. This arrangement is made compulsory because of the particular configuration of the rotor/wing system. During the rotary-wing mode, the rotor/wing system produces lift which oscillates constantly forward and backward, longitudinally about the axis of rotation of the rotor/wing system. In order to reduce the resulting vibrations and potential effect on the stability of the flight, the center of gravity of the aircraft is purposely located significantly far away from the axis of rotation of the rotor/wing system, somewhere between the two set of vertical rotor systems. During fixed-wing mode the second rotor system requires the addition complexity of a tilt mechanism so that they can contribute to horizontal flight, and the vertical lift necessary to maintain balance is transferred to a lifting canard wing. The lifting canard wings may be a significant weight penalty during rotary-wing mode. The use of the second rotor system, selectively as a mean to produce horizontal trust during fixed-wing mode and as a vertical rotor system during rotary-wing mode generally results in a reduction of efficiency.

### SUMMARY OF THE INVENTION

It is the main object of this invention to provide a method and system to enable efficient and safe transition between the two different flight modes in the type of aircrafts generally referred as rotor/wing aircrafts or stop-rotor aircrafts.

Another objet of the invention is to provide a vertical take-off and landing aircraft capable of efficient rotary-wing mode, efficient fixed-wing mode and having the ability to transit rapidly between these two flight modes.

Another object of the invention is to provide for a low disc loading VTOL aircraft which has a high speed cruise capacity while having a moderate weight and complexity penalty.

A further objet of the invention is to provide for a vertical take-off and landing aircraft having high speed, long range and high cargo capacity with increase center of gravity travel capability.

This is achieved as described in the preferred embodiment of the present invention, by an aircraft comprising a second rotor/wing which is mechanically connected to the first rotor/wing. The first rotor/wing connects to a transmission shaft above the fuselage and the second rotor/wing connects to another transmission shaft at the bottom of the fuselage. During the rotary-wing mode the two rotor/wings rotate coaxially to produce vertical lift. In the fixed-wing mode the two rotor/wings are stopped simultaneously transverse to the longitudinal axis of the fuselage and produce vertical lift as fixed wings.

During transition between rotary-wing and fixed-wing mode, the synchronous operation of the second rotor/wing with the first rotor/wing maintains lateral balance and vertical lift. Transition is stable without the aircraft losing altitude and experiencing any dangerous turning moment. As the reactions of the two rotor/wings on the aircraft due to sudden stopping or starting are also equal and opposite, their effects on the aircraft is cancelled. The rotor/wings can be started or stopped very rapidly without affecting the flight stability.

During the rotary-wing mode the second rotor/wing improves the efficiency by eliminating the need of an anti-torque device in the form of a lateral tail rotor. The coaxial operation of the two rotor/wings also provides a stable vertical flight and hover characteristic. During the fixed-wing flight mode, the second rotor/wing may contribute to vertical lift together with the first rotor/wing in a biplane configuration thus significantly reducing the wingspan of both rotor/wings. The existing onboard mechanism which operates the rotor/wings system can also be use to pivot one of the rotor/wing in alignment with the longitudinal axis of the fuselage so that only a single rotor/wing is used for higher speed. Similarly, both rotor/wings may be pivoted in an oblique position on either side of the fuselage for a high aspect ratio configuration. The rotor/wings may also be folded in a variety of ways.

The claimed invention is a great improvement over the auxiliary fixed wings in most prior arts. These auxiliary wings would assist only during transition while interfering negatively during both flight modes, whereas the second rotor/wing in the present invention contributes to both flight modes and enables a practically smooth and rapid transition between the rotary-wing and fixed-wing mode. As the two rotor/wings are mounted on separate transmission systems they are less complex. The coaxial rotor/wing aircraft has the advantage of a very low weight and complexity penalty and would offer a better transport effectiveness than conventional helicopters and airplanes. Another advantage of the coaxially connected rotor/wings is that the airfoil cross-section of the rotor/wings can be designed to have a preferred leading and trailing edge which is most efficient for fixed-wing mode. The resulting imbalance lift of the two rotor/wings during rotary-wing mode compensates each other, without the need of complex mechanism.

Manned aircrafts in the general aviation category and most particularly the personal air vehicles commonly referred as PAV can greatly benefit from this invention. The reduced complexity, efficiency and stability of the vertical take-off and landing ability inherent to coaxial rotorcraft, offer the possibility of affordable efficient flying machines capable of providing a ‘door to door’ travel capacity, as an alternative to motor-vehicles. The coaxial rotor/wings and the biplane configuration allow very compact design. Because transition between rotary-wing mode and fixed-mode is relatively simple, the process can be automated at reduced cost. Such aircrafts would automatically convert between the two flight modes, depending on the forward speed, and would practically never stall. This would lead to a considerable reduction in skill required to operate such an aircraft.

Embodiments of the invention have also wide surveillance and military applications, ranging from micro air vehicles, unmanned drones, and manned VTOL aircrafts of various capacities. Such aircrafts will be truly agile with the increase ability to vary direction and speed, by transiting rapidly as often as required between flight modes without losing stability and flight control. Embodiments of the invention surpass traditional helicopters in speed, range and efficiency. By simple reconfiguration of the rotor/wings, high efficient subsonic or supersonic speed becomes possible.

Embodiments of the invention can have the comparable load capability of a large cargo or passenger tandem helicopter, with the range and speed of a jet liner, by far exceeding the abilities of current tilt-rotor aircrafts. The higher lift requirement in such embodiments during rotary-wing mode can be fulfilled by a plurality of smaller coaxial rotor/wings fitted to the same fuselage. In fixed-wing mode the plurality of coaxial rotor/wings are also used to produce vertical lift, for example, as tandem or triplet wings. In some other embodiment the rotor/wings may be used as canard and tail wings, while relying on a permanent auxiliary fixed wing to produce most of the vertical lift. These canard and tail wings would generate positive or negative lift as required in order to maintain longitudinal static stability under variable center of gravity location depending on loading condition.

### BRIEF DESCRIPTION OF THE DRAWINGS

The preferred embodiments of the present invention are described in detail with reference to the following drawings:

FIG. 1 is a perspective view of the preferred embodiment of an aircraft in accordance with the disclose invention, shown in fixed-wing flight mode.

FIG. 2 is a perspective view of the aircraft in FIG. 1, shown in rotary-wing flight mode.

FIG. 3 is a schematic layout of the rear part of the aircraft in FIG. 1, and shows the main components of the coaxial rotor/wings in accordance with the invention.

FIG. 4 is the side view of another embodiment of the rotor/wing aircraft according to the invention, shown in fixed-wing flight mode.

FIG. 5 is the top view of the embodiment of the aircraft in FIG. 4, shown in fixed-wing flight mode.

FIG. 6 is the front view of one variation of the embodiment of the aircraft in FIG. 4, with the tips of the lower rotor/wing folded downward, during fixed-wing flight mode.

FIG. 7 is the front view of a variation of the embodiment of the aircraft in FIG. 4, with the both rotor/wing folded in a cross-wing configuration, during fixed-wing flight mode.

FIG. 8 is a top view of another embodiment of an aircraft shown in fixed-wing mode with both wings pivoted in an oblique position.

FIG. 9 is a perspective view of an aircraft for higher load capacity, consisting of two set of coaxial rotor/wings and a main fixed-wing, shown during fixed-wing flight mode.

### DETAILED DESCRIPTION OF THE INVENTION

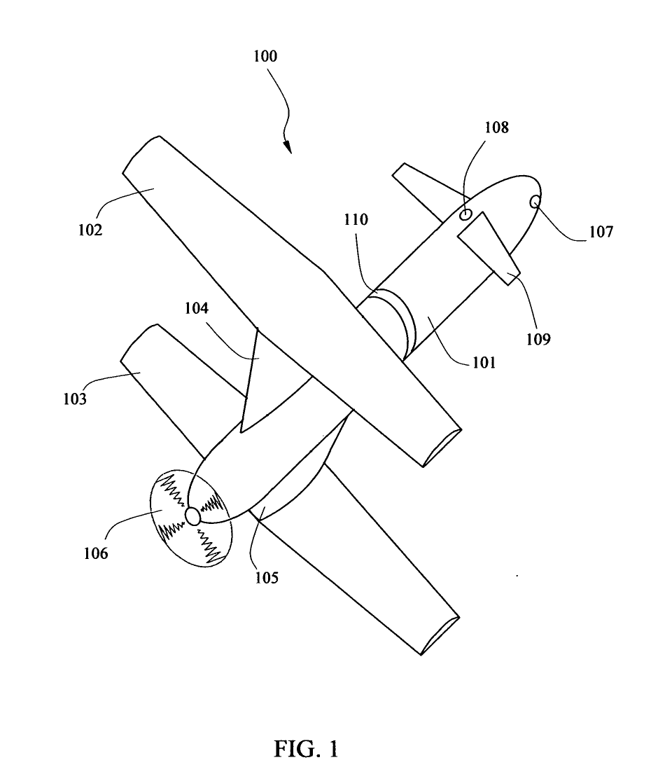

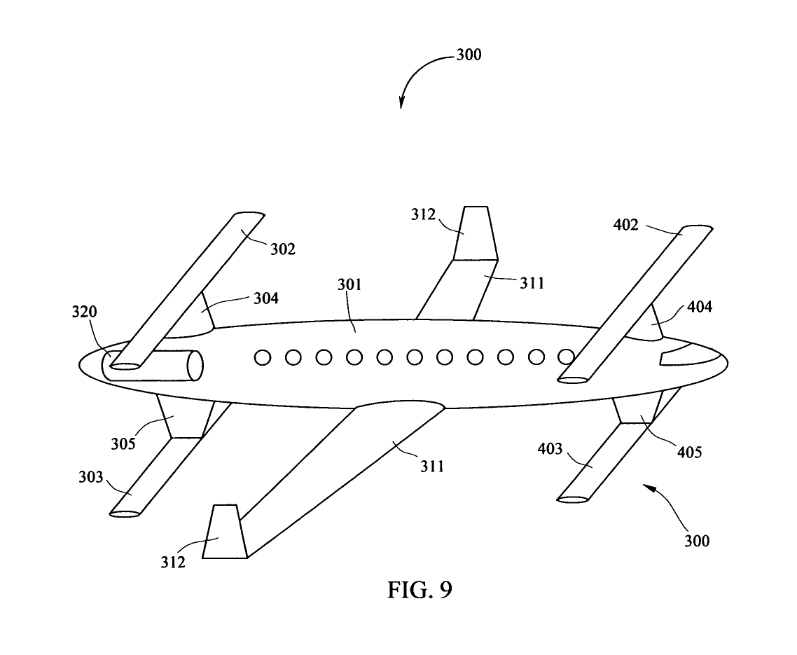

The invention is described mainly with reference to the embodiment of an aircraft shown FIGS. 1-3, and with cross reference to other embodiments as shown in the accompanying drawings. In the drawings FIGS. 1-8, corresponding components are designated by the same numerals. In FIG. 9, different numbers are used to designate similar components.

### Concept and Structure

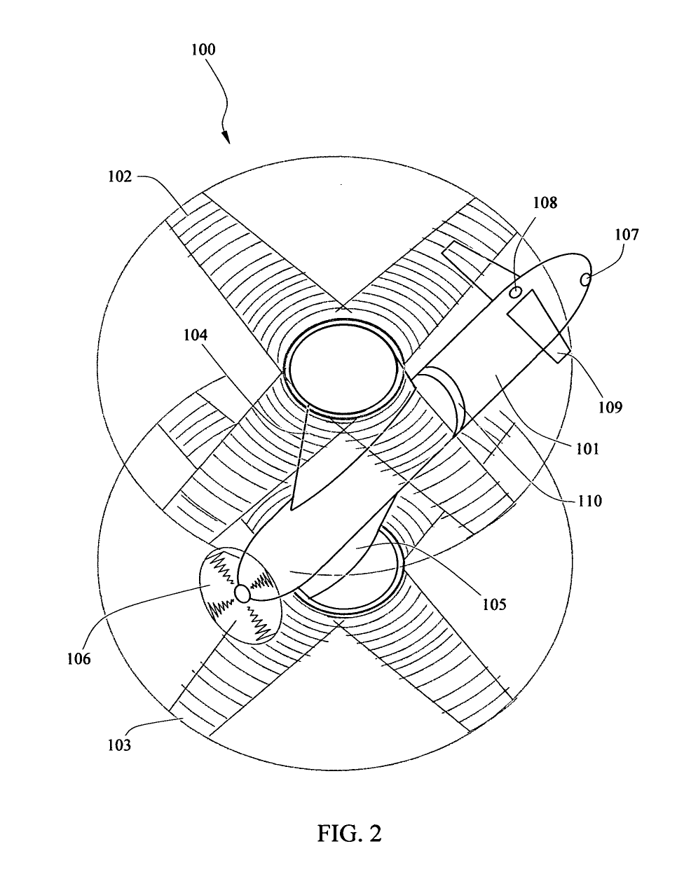

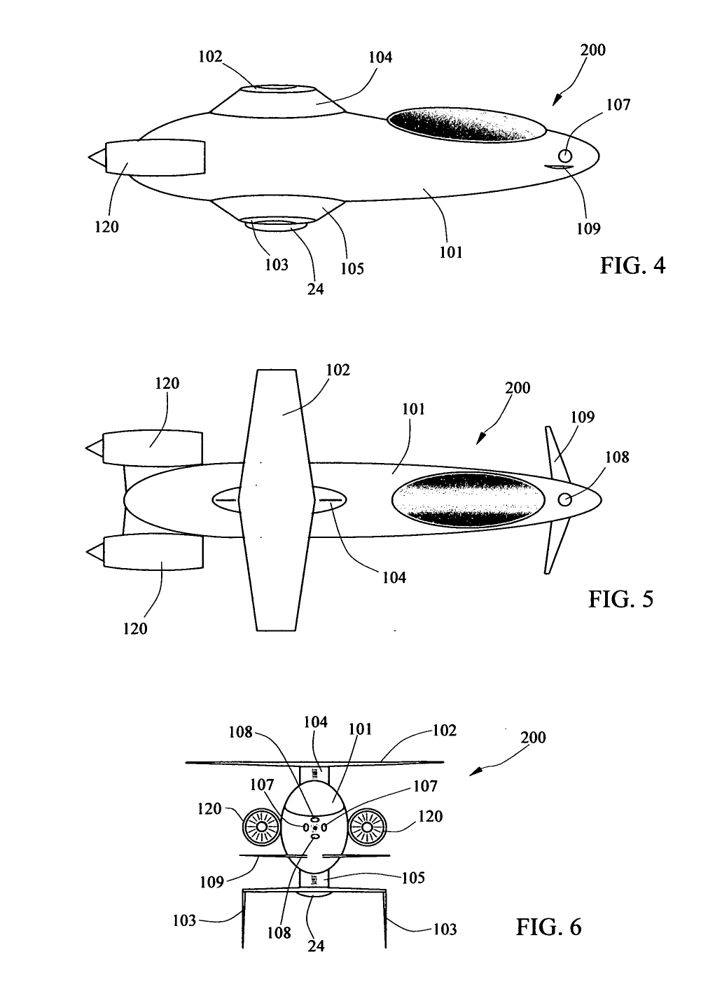

The aircraft 100 is shown in a fixed-wing flight mode in FIG. 1 and in a rotary-wing flight mode in FIG. 2. The aircraft 100 comprises an upper rotor/wing 102 which is rotatably coupled to the fuselage 101 on top of a mast fairing 104, and a lower rotor/wing 103 which is rotabably coupled to the fuselage 101 below a mast fairing 105. These mast fairings 104 and 105 are streamlined in order to reduce aerodynamic drag and also enclose the transmission shafts, control devices and other components which secure the rotor/wings 102 and 103 to the fuselage 101. In aircraft 100, the mast fairings 104 and 105 also comprise the vertical stabilisers, and instead of a conventional rear tail a canard wing 109 is used for pitch control. The mast fairing 104 is comparatively longer than the lower mast fairing 105. This lower the center of gravity of the aircraft 100 below the combined center of lift of the two rotor/wings, and provide a stronger supporting structure for the landing gears, which is connected at the underside of the lower rotor/wing 103. However in some other embodiments, the mast fairings 104 and 105 may be equal in length and symmetrical. In other embodiments as shown in FIG. 4-8, the upper mast fairing 104 and the lower mast fairing 105 may be designed relatively very short for increased structural strength. Separate vertical stabilisers or equivalent devices need to be provided. As shown in FIG. 8 the aircraft 202 comprises conventional vertical stabilisers 113 and rear tail 112.

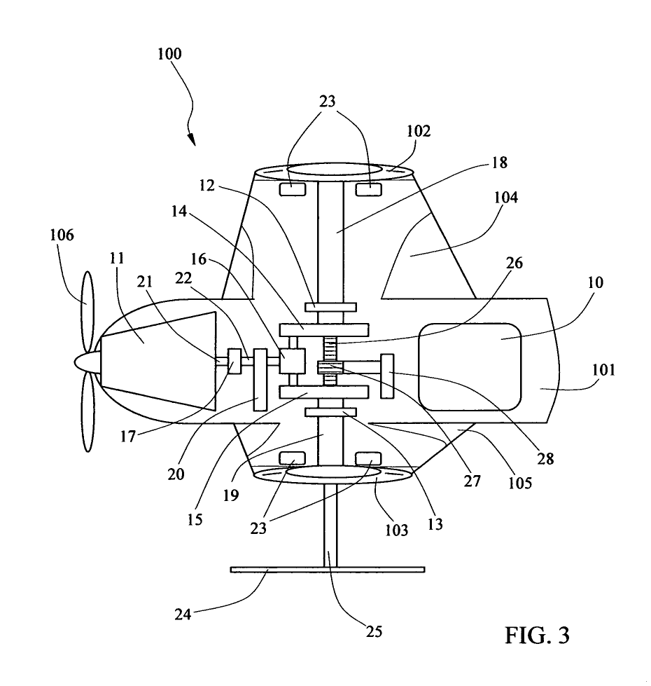

The fuselage 101 accommodates the passenger or payload compartment at the front and the mechanical compartment at the rear, in an arrangement which is most common in rotary aircrafts. As shown in FIG. 3, the mechanical section comprises the main power components such as the engine 11, the transmission system for the rotor/wings 102 and 103, the power source or the fuel tank 10, and other essential components necessary to enable safe and reliable flight in both flight modes.

The rotor/wings 102 and 103 are coaxial and mechanically linked together. The rotor/wings 102 and 103 rotate at the same speed and are in phase, where the leading edge of the upper rotor/wing 102 is the mirror image of the leading edge of the lower rotor/wing 103 along the longitudinal axis of the fuselage 101. As shown in FIG. 3, the upper rotor/wing 102 is coupled to the transmission 14 by means of a transmission shaft 18 which comprises the swash plate 12 and the control rods. Similarly, the lower rotor/wing 103 is coupled to the transmission gear 15 by means of a transmission shaft 19, which comprises the swash plate 13 and the control rods. The transmissions 14 and 15 connect to the drive shaft 21 of the engine 11 through a gearbox 16. The gearbox 16 divides the output of the drive shaft 21 into two identical counter-rotating drive shafts which connect to the respective transmissions 14 and 15. The gearbox 16 is coupled to the engine shaft 21 through a clutch 17, which allows the engine shaft 21 to be engaged or disengaged from the gearbox 16, depending on the flight mode. The transmissions 14 and 15 remain mechanically connected by mean of the gearbox 16 during both rotary and fixed-wing mode. The swash plates 12 and 13 enable to access and operate the control surfaces on the rotor/wings 102 and 103 in both flight modes.

During transition from rotary-wing to fixed-wing flight mode, the rotor/wings 102 and 103 are slowed and stopped simultaneously transverse to the longitudinal axis of the fuselage 101, as shown in FIG. 1. During this operation, the clutch 17 disconnects the engine shaft 21 from the transmission system of the rotor/wings 102 and 103 and a positioning mechanism 20 is activated. The positioning mechanism 20 slows down and stops the shaft 22 so that the rotating wings 102 and 103 are aligned in a biplane configuration as shown in FIG. 1. The simplest embodiment of the positioning mechanism would consist of a drum and frictional pad arrangement to produce the strong braking force, and a spring driven or motor driven mechanism to stop the shaft 22 is a specific position. The rotor/wings 102 and 103 are then secured to the fuselage 101 by locking mechanisms 23 and the control surfaces on the rotor/wings are adjusted for fixed-wing mode so as to produce aerodynamic lift as fixed wings. The synchronized operation of the rotor/wings 102 and 103 ensures that the dissymmetry of lift of the first rotor/wing is compensated by the dissymmetry of lift of the second rotor/wing, thus lateral balance is maintained throughout the transition. At the same time, the reaction force on the fuselage 101 by of the rotor/wings 102 and 103 mutually cancel themselves as the forces are equal and opposite in direction, provided of course the rotor/wings 102 and 103 have similar rotational inertia. During transition from fixed-wing mode to rotary-wing mode, the lateral balance is also maintained and the reaction force of the rotor/wings 102 and 103 also cancel mutually. In this case the rotor/wings 102 and 103 are unlocked and set in rotation when the clutch 17 couples the gearbox 16 to the engine 11. The control surfaces on the rotor/wings 102 and 103 are adjusted for rotary-wing mode so as to produce vertical lift.

The propeller 106 provides horizontal trust during both flight modes. The propeller 106 and the rotor/wings 102 and 103 are powered by the same engine 11. During rotary-wing mode, most of the power of the engine 11 is diverted to drive the rotor/is wings 102 and 103 and a smaller portion is diverted to the propeller 106. During fixed-wing mode, all the power is diverted to the propeller 106. The propeller 106 may be ducted or even of the contra-rotating type. The engine 11 may consists of several interconnected engines for increased reliability, and could be of a variety of types suitable for aircrafts, such as piston engines, jet engines, gas turbines, wankel engines, or electrical motors. In other embodiments, multiple engines may be installed on either side of the fuselage 101, as shown in FIG. 4-7. In some other embodiments the engine 11 may be located at some other location and the aircraft 100 in puller or puller/pusher propeller configuration. In another embodiment 202 as shown in FIG. 8 the jet engines 120 are installed in the rear of the fuselage 101 with air-intakes 121 on either side at the front, in an arrangement most familiar with supersonic aircrafts.

In aircrafts equipped with jet engines or gas turbines, the rotor/wings 103 and 104 can be powered in either a conventional way as explained earlier, or in a tip jet propulsion arrangement. The tip jet arrangement is popular in rotor/wing aircrafts because it eliminates the need of an anti-torque device during the rotary-wing mode. But these aircrafts experience the same destabilizing forces explained earlier during transition between flight modes, and these problems are overcome in a similar way as described earlier by the coaxial rotor/wings arrangement. In these aircraft, the upper rotor/wing 102 and the lower rotor/wing 103 remain mechanically, connected even if the tip jets are installed in one or both rotor/wings. The drive shaft 21 and clutch 17 are replaced by ducting and other components particular to tip jet systems and the transmissions systems are designed less robust and simpler. The transmissions 14, 15 and the gearbox 16 are used to synchronise the rotation and relative position of the two rotor/wings 102 and 103, and at the same time to couple and cancel the turning moments generated by each rotor/wings, as the result of lift asymmetry and reaction forces on the fuselage 101 due to operation of the rotor/wings, during transition.

The preferred embodiments comprises as explained above, an upper rotor/wing 102 and a lower rotor/wing 103 on separate shafts and separate transmission in a coaxial arrangement, because this configuration is the most efficient, reliable and easy to implement. However, those skilled in the art will understand that a plurality of rotor/wings may be mounted to the fuselage in a counter-rotating configuration and operated together in coordination so as to reduce the destabilizing forces during transition. For example the rotor/wings may be arranged in a tandem configuration. Similarly two smaller rotor/wings may be operated in counter-rotation with a larger rotor/wing. These rotor/wings may be located above or below the fuselage. In fixed-wing mode the aircraft can take a variety of configuration depending on the position of the rotor/wings, such as staggered biplane, tandem or triplet wings. The plurality of rotor/wings of different dimension and varied location on the fuselage may have different operating parameter in order to reduce lateral unbalance during transition.

It has to be noted that herein, the term ‘rotor/wing’ may have a variety of constructional embodiment. The rotor/wings may be constructed similar to helicopter rotor comprise of a plurality of wings mounted on a rotor hub, whereby the rotor hub by a transmission shaft in order to produce vertical lift during rotary-wing flight mode, and where these rotor/wings also produce aerodynamic lift similar to fixed wings when the rotor is locked during fixed-wing flight mode. It should also be noted that the term ‘blades’ is often used to refer to rotating wings mounted on a rotor hub. Similarly the rotor/wing may be constructed similar to convention fixed wing, comprising of one continuous transversal panel mounted at its mid section on a rotating support or hub. The term coaxial rotor/wings herein, refers to a set of two rotor/wings which are mounted on the same vertical axis and rotate coaxially and in phase relative to each other, and where these two rotor/wings are simultaneously stopped or set in rotation. The coaxial and synchronous operation of these rotor/wings may be achieved by a variety of means, comprising mechanical gears or other electromechanical, electromagnetic, pneumatic, hydraulic or equivalent devices which enable the coupling and canceling of the forces transmitted by the rotor/wing to the fuselage of the aircraft.

### Rotary-Wing Flight Mode

During the rotary-wing mode, the aircraft 100 is able to take off vertically, land vertically, hover and fly at low speed (speeds that are below the stall speed of the fixed-wing mode) with a high degree of manoeuvrability and efficiency, similar to helicopters. The aircraft 100 is operated in the same manner like a helicopter with coaxial rotors

The two rotor/wings 102 and 103 mutually cancel the turning moment on the fuselage 101 and hence eliminate the need of an anti-toque device as required in helicopters with single rotor or in aircraft with single rotor/wing driven by a conventional transmission. The coaxial rotor/wings provide all the advantages related to helicopters with coaxial rotors, such as: a smaller wingspan; high stability during vertical lift; lower noise; lower vibration; and higher efficiency. The mechanical complexity is reduced given that the rotor/wings 102 and 103 are installed on separate transmissions 18 and 19, mounted on separate mast fairings 104 and 105.

As shown in FIG. 3, during rotary-wing mode the clutch 17 connects the shaft 21 to the shaft 22 so the engine 11 drives the upper transmission shaft 18 and the lower transmission shaft 19 coaxially. The shafts 18 and 19 drive their respective rotor/wings 102 and 103 through appropriate coupling mechanisms and hub assemblies. Vertical lift is obtained by collectively changing the pitch of the rotor/wings 102 and 103, or control surfaces or flaps. The lift acts through the axis of rotation of the rotor/wings. The center of gravity of the aircraft 100 is located below and in alignment with the center of lift generated by the two rotor/wings 102 and 103 for stability. The aircraft 100 may include means to compensate for unequal payload distribution by shifting the center of gravity of the aircraft to the optimum location, such as redistribution of fuel in several ballast tanks.

Horizontal flight in rotary-wing flight mode is achieved principally by the propeller 106 alone, or in some embodiments in combination with cyclic control of the rotor/s wings 102 and 103 for higher agility and manoeuvrability. The yaw control and steering is achieved by mean of conventional helicopter devices or controlled dissymmetry of torque in the rotor/wings 102 and 103 as used in coaxial helicopter. In the prefer embodiments, this is achieved by lateral thrusters 107 located on either side of the nose end encased in the fuselage 101 so that they do not create aerodynamic drag during forward flight. Vertical thrusters 108 are also fitted as shown in aircraft 100 and the other preferred embodiments on the top and bottom side of the fuselage 101 so as to provide additional flight control during hovering and slow forward flight. These thrusters 107 and 108 are powered by compressed air from the engine 11 or the exhaust (not shown).

### Fixed-Wing Flight Mode

During fixed-wing mode the rotor-wings 102 and 103 are positioned in a biplane configuration and firmly secured to the fuselage 101 by a set of locking devices 23. The corresponding leading and trailing edges of the rotor-wings 102 and 103 are configured for fixed-wing flight mode so that at least one of the rotor/wing produces vertical aerodynamic lift like fixed wings, and the propeller 106 providing horizontal trust. The aircraft 100 is operated in the same manner like an airplane by mean of flight control surfaces on the rotor/wings 102 and 103, and the vertical stabilisers incorporated in the mast fairings 104 or 105. The preferred embodiments 100 and 200 include a canard wing 109 at the front for improved pitch control in the fixed-wing mode, instead of a tail wing. The canard wing 109 is preferably on the top of the fuselage 101 so as to ensure good downward visibility for the pilot and passengers. During rotary-wing mode the canard wing 109 is may be retractable or foldable to ensure improved upward visibility during slow maneuver. In other embodiments as shown in FIG. 8, a rear horizontal stabiliser 112 may be used, instead of, or in combination with a canard wing.

For embodiments of the invention within the range of 300 km/hr similar to personal aircraft both rotor/wing may used to produce vertical lift. Biplanes have comparable efficiency to single wing aircraft with some extra advantage. Biplanes have smaller wing span and generate more lift for the same platform area. The wingspan may be reduced even further, considering that aircrafts that take-off and land vertically, do not need wings with large platform area, resulting in reduced drag. Biplanes are still by far more efficient and faster that helicopters.

For even greater speed, the initial biplane configuration can be modified further during fixed-wing mode. As shown in FIG. 8, the rotor/wings 102 and 103 of the embodiment 202 may be pivoted about their transmission shafts, so that they form two symmetrically opposing oblique wings with a high aspect ratio. This is carried out by the positioning mechanism 20 turning the shaft 22 by a certain define amount. In other embodiments, the aircraft may include feature which independently position the rotor/wings so that one rotor/wing is aligned with the longitudinal axis of the fuselage and the other rotor/wing is maintained transverse to the longitudinal axis or in an oblique orientation to the fuselage to provide lift in a single wing configuration.

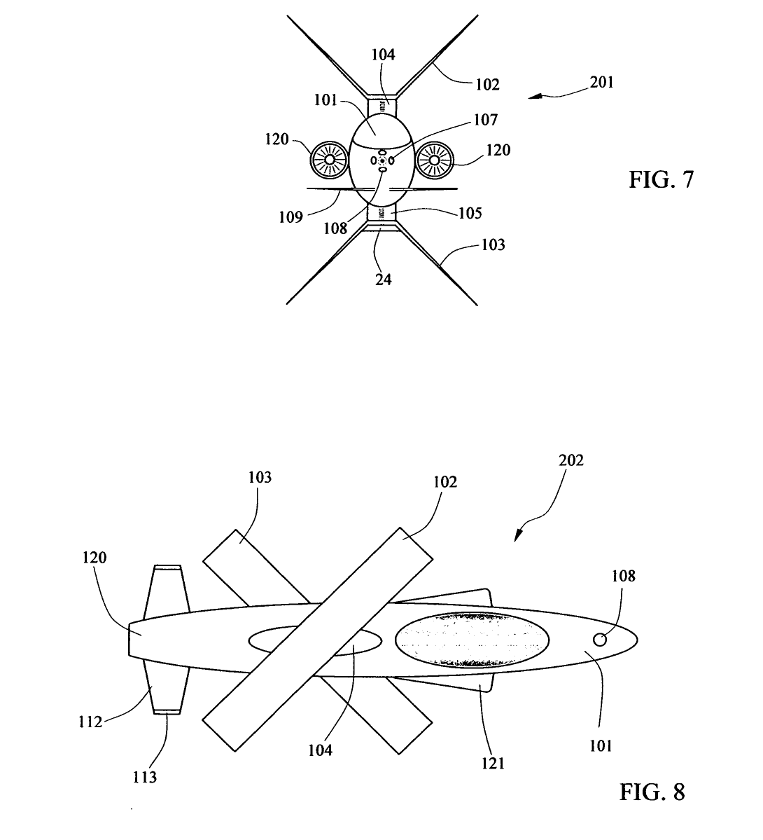

In some other embodiment the lower or upper or both rotor/wings may be retracted or folded in a variety of ways so as to operate as vertical stabiliser. For example as shown in FIG. 6, sections of the lower-wing 103 are folded downward and used as twin vertical stabilisers. In other embodiments, the lower/wing 103 may be flipped in an inverted V-tail configuration. In yet other embodiment 201 as shown in FIG. 7, the rotor/wing 102 is folded upward in a dihedral configuration and the second rotor/wing 103 is folded downward in an anhedral configuration. This configuration reduces the interference between the two rotor/wings and at the same time operates as vertical stabilisers. As shown in FIG. 4-7, in the embodiments of the aircraft designed for high speed, the masts fairing 104 and 105 are built short so as to provide stronger support for the rotor/wings.

In the fixed-wing mode, the center of lift of the aircraft 100 is ahead of the axis of rotation of the rotor/wings, at about the quarter-chord point from the leading edge of the rotor/wings 102 and 103. In order to maintain longitudinal static stability, the center of gravity of the aircraft 100 is shifted forward, ahead of the center of lift acting on the aircraft. The passenger or payload compartment which is mounted in a telescopic arrangement with the rear part of the fuselage 101, slides forward at the junction 110 by a define amount, driven by actuators and secured by appropriate locking devices (not shown). This arrangement changes the aircraft 100 in a nose heavy configuration, which is particularly advantageous for personal aircraft. In the event of engine failure, the aircraft will assume a normal glide for a safe landing. In embodiment shown in FIG. 4, the canard wing 109 produces a negative lift so as to displace the neutral point backward, without displacing the center of gravity of the aircraft 200. In other embodiment 202 as shown in FIG. 8, a tail wing 112 would produce the same effect by producing a positive lift. In yet another embodiment the center of gravity may be shifted by displacing a define amount of fuel between ballast tanks at the extreme ends of the aircraft. It is understood that addition horizontal and vertical stabilisers may be included as dictated by the aircraft configuration and the laws of aerodynamic.

### Transition Between Flight Modes

Transition from rotary-wing mode to fixed-wing mode is carried out when the aircraft exceeds the horizontal stall speed by a certain safety margin. Transition is completed when the longitudinal static stability of the aircraft 100 is adjusted by displacing the center of gravity forward or by a negative lift by the canard wing 109 in aircraft 200.

During transition, the coaxial rotor/wings 102 and 103 continue to produce vertical lift which is laterally balanced. The vertical lift during transition is easily maintained constant by collective control of the control surfaces on the rotor/wings 102 and 103. The equal and opposite reaction forces of the coaxial rotor/wings 102 and 103 on the fuselage 101 cancel each other, while the rotor/wings are being slowed and stopped. The rotor/wings can hence be stopped very quickly if required. However, since lateral balance of lift and vertical lift are maintained during the transition, it becomes no longer necessary to make transition rapidly. Transition becomes a safe, smooth and simple operation, which can be carried out quickly or gradually. As the aircraft does not suffer loss of altitude, transition may be carries out safely at low altitude. The transition process is very reliable as it does not require complex control operation.

Transition from fixed-wing mode to rotary-wing mode is carried out in reverse sequence at the minimum safe horizontal speed for fixed-wing flight. The center of gravity of the aircraft 100 is gradually shifted backward and aligned with the axis of rotation of the rotor/wings. The rotor/wings 102 and 103 are reconfigured for rotary-wing mode, unlocked and set in rotation as the dutch 17 connects the engine shaft 21 and the input shaft 22 of the gearbox 16. The coaxial rotor-wings maintain lateral lift and cancel all turning moments on the fuselage and enable rapid and smooth transition to rotary-wing mode. The canard wings 109 may be folded or retracted, and the aircraft is operated like a conventional coaxial helicopter.

The twin coaxial rotor/wings 102 and 103 do not operate in severe high speed condition since transition to fixed-wings mode is carried out at much lower horizontal speed, where problems such as flapping of the wings and vibration is not of great concern. Vibration during rotary-wing mode and transition is less severe and may be efficiently damped by appropriate damping mechanisms.

### Landing Gears

Rotor/wings aircrafts in the present invention retain the ability to take-off and land in either fixed-wing or rotary-wing mode. This is a desirable feature since in fixed-wing mode the aircraft would have a higher payload. Such an aircraft can take off in a fixed-wing mode with a higher load of fuel for long rang operation, and once the extra fuel has been used the aircraft can operate in both flight mode. Similarly, the aircraft may land in a fixed-wing mode in case of some transmission or engine failure. Hence the aircraft would in most embodiments include landing gears suitable for fixed-wing mode and rotary mode. The landing gears for fixed-wing mode may consist of a classical tricycle arrangement, with one set of wheel at the front and two set of wheels at the rear. The rear wheels can be deployed from cavities in the lower wings 103, or from either side of the fuselage 101 (not shown).

Vertical take-off and landing in rotary-wing mode in most embodiments of the aircraft is achieved by means of a different landing gear which is found at the underside of the lower rotor/wing 103. The landing gear as shown in FIG. 3 comprises of a platform 24 which connects to the inside non-rotating part of the aircraft by mean of an extension shaft 25, passing through the transmission shaft 19 of the lower rotor/wing 103 which is hollow. The platform 24 is centered on the axis of rotation of the rotor/wings which is also in alignment with the center of gravity of the aircraft 100 during rotary-wing mode. The platform 24 is wide enough to provide a stable support to the aircraft and remain stationary when the rotor/wing 103 is rotating. The extension shaft 25 is supported inside the hollow transmission shaft 19 on bearings arrangement so as to reduce friction between them. The shaft 25 is long enough in order to provide sufficient clearance between the lower rotor/wing 103 and the ground surface.

In more elaborate landing gears as shown in FIG. 3 the platform 24 may be locked in one position close to the fuselage 101 so as to reduce aerodynamic drag and in another position in order to allow easy access to the cabin. The lower and upper transmission shafts 18 and 19 are both made hollow so that the shaft 25 can travels freely inside. The side of the shaft 25 comprise a rack 26 which meshes with a pinion 27. Rotation of the pinion 27 allows the shaft 25 to be raised or lowered as required and locked in the required position by a device 28. The pinion 27 can be driven from power derived from the main engine 11 or from a separate motor.

When the aircraft is ready to take-off, the shaft 25 is pulled out to its maximum extended position so as to provide maximum clearance between the ground and the rotor/wing 103 for safety reason, before the rotor/wings are set in rotation. Once the aircraft is off the ground the platform 24 is pulled closer to the fuselage 101 in some intermediate position within a safe minimum clearance from the rotating wings 103, in order to reduce drag. During the fixed-wing mode, the platform 24 may be pull further in close contact with the lower rotor/wing 103 so as to reduce drag further.

The platform 24 could consist of a simple frame or a body as shown in FIG. 6 and FIG. 7 that could contain several other devices such as retractable wheels, useful for parking or landing in airplane mode. Similarly, the platform 24 may include various anchoring device which hold the aircraft firmly to the ground, until the vertical lift has reached a desired level to enable a rapid ascend, and at the same time to overcome the ground effect phenomena and avoid sideway drifts. One such anchoring device may comprise of a cavity in the underside of the platform 24 at the surface of contact with ground, and which is kept at low pressure by a vacuum pump or by the suction of the engine until the aircraft is allowed to take-off.

### Multiple Coaxial Rotor/Wing Aircrafts

FIG. 9 shows the preferred embodiment of an aircraft 300 designed for large cargo, consisting of more than one set of coaxial rotor/wings in order to generate greater lift. The aircraft 300 comprised of two set of coaxial rotor/wing mounted at the front end and the rear end of the fuselage 301, referred respectively as the canard rotor/wing and a tail rotor/wings. The coaxial rotor/wing at the front end comprises of the upper rotor/wing 402 and a lower rotor/wing 403 mounted coaxially on their respective mast fairings 404 and 405. The coaxial rotor/wings at the rear arrangement comprises of an upper rotor/wing 302 and lower rotor/wing 303 mounted coaxially on their respective mast fairing 304 and 305. The coaxial rotor/wings are powered by twin jet engines 320 at the rear on either side of the fuselage 301. The jet engines 302 also provide horizontal trust in both flight modes. It is understood that the two coaxial rotor/wings may be of different wingspan and installed on mast of different height so as to minimise interference between them. Similarly the two set of coaxial rotor/wings may be mechanically interconnected, as they may not necessarily be connected and hence operated at different rotational speed during rotary-wing mode. In both case the coaxial rotor/wings are controlled independently.

In some embodiment the two set of coaxial rotor/wings, may be sufficient to sustain vertical lift during rotary-wing mode and during fixed-wing mode in a tandem biplane configuration. In other embodiments designed for even heavier load more than two set of coaxial rotor/wings may be required. The wingspan of coaxial rotor/wings is significantly smaller than single rotor/wing, for the same lift. However the wingspan of the rotor/wings may have to be limited in order to avoid overlapping between the multiple set of coaxial rotor/wings. The rotor/wings in such large aircraft may have to operate in a medium or higher disc loading during the rotary-wing mode and these rotor/wings alone may not produce enough vertical lift during fixed-wing mode. This problem is solved by means of a set of permanent fixed wing 311 at about the middle section of the fuselage 301. During fixed-wing mode, the permanent fixed wing 311 provides most of the vertical lift same like the main wing in an airplane, whereas the coaxial rotor/wings are used as canard and tail wings in a biplane configuration, as shown in FIG. 9. Vertical stabilisers 312 are provided on the tip of the fixed wing 311. Alternatively a rear vertical stabiliser may be mounted at the rear, or the rotor/wings 302 and/or 303 folded in order to act as vertical stabilisers. Depending on the location of the center of gravity of the aircraft, which may variable due to loading condition, the rotor/wings 302 and 303 at the rear, and the rotor/wings 402 and 403 are configured to produce vertical or negative lift as required, in order to maintain longitudinal stability during fixed-wing mode. Similarly, during rotary-wing mode, the vertical lift of the coaxial rotor/wings at the front and at the rear may also differ depending on the variable loading condition.

The jet engines 320 provide the horizontal trust for the aircraft 300 to move forward. The aircraft 300 includes horizontal and vertical thrusters or equivalent devices for steering and flight control in the rotary-wing mode (not shown). Transition between rotary-wing mode and fixed-wing mode takes place when the fixed wing 311 generates enough vertical lift to sustain the aircraft 300 in fixed-wing mode. The ability of the coaxial rotor/wings to be stopped or started quickly without affecting the stability of the aircraft enable the different set of coaxial rotor/wings to be slowed and stop for fixed-wing mode simultaneously for a fast transition. The two sets of coaxial rotor/wings may also be operated sequentially and gradually for a very smooth transition between the two flight modes in coordination with the fixed wing 311.

The aircraft 300 equipped with appropriate landing gears (not shown) retains the ability to take-off and land on a runway like an airplane to carry a greater payload. Such an aircraft could take off in fixed-wing mode with a higher payload of fuel or troops and then continue its operation in dual flight modes when the load has been reduced.

The preferred embodiments of the invention as illustrated in the accompanying drawings and descriptions are applicable for manned or unmanned aircrafts of wide range of size whether for military, commercial or personal use. The embodiment 100 as shown in FIG. 1 and FIG. 2 is most appealing for aircrafts in the range of speed and characteristics of small personal aircrafts, unmanned drones and micro aerial vehicles, due to a compact design. Embodiment 200 as shown in FIG. 4 and FIG. 5 is fitted with twin jet engines and is suitable for high speed manned or unmanned aircrafts. As vertical stabiliser are most useful in fixed-wing mode, and as a way of reducing the drag and mass penalty due to a tail wing and fuselage extension at the rear to support the wings, the rotor/wings are folded in a variety of ways as shown in FIG. 6 and FIG. 7 after transition to fixed-wing mode to serve as a vertical stabiliser. Embodiment 202 as shown in FIG. 8 is a very high speed aircraft suitable for military application. The aircraft has a conventional fighter aircraft configuration with rear tail 112 and vertical stabilisers 113 in H-configuration, and achieve very high speed with high efficiency by pivoting the wings 102 and 103 in an oblique wings configuration as shown. The aircraft 202 is powered by a single or more jet engines 120 with twin air-intakes 121 at the front. Embodiment 300 in FIG. 9 comprises a tandem coaxial rotor/wings convenient for larger aircrafts with increased cargo capacity, suitable for military and civil application. All the embodiments of the invention retain the full operational advantage of a typical helicopters and an airplane. The safety of these types of aircrafts is enhanced because of reduction in complexity and safe transition. In case of engine failure these aircrafts may land in emergency in a gliding mode or in autorotation.

While the invention has been describe in detail with refer to some specific embodiments, it is understood that various variations may still be made without departures from the spirit and scope of the invention, and that the specification and drawings are to be considered as merely illustrative and not limiting:

The embodiments of the inventions in which an exclusive property or privilege is claimed are defined as follows:

1. An aircraft having a first flight mode, a transition flight mode and a second flight mode comprising:
a fuselage;
a first group of rotor/wings comprising at least one rotor/wing;
a second group of rotor/wings comprising at least one rotor/wing;
at least one propulsion unit to provide forward thrust;
at least one engine to power said propulsion unit and said rotor/wings;
wherein said rotor/wings comprising of a plurality of wings rotatably mounted to said fuselage;
wherein during said first flight mode, said first group and said second group of rotor/wings rotate in counter-rotation to produce vertical lift;
wherein during said second flight mode, said rotor/wings are not rotating and at least one said rotor/wing is positioned to produce aerodynamic lift as fixed wings;
wherein during said transition flight mode when said aircraft is transiting between said first flight mode and said second flight mode, said first group of rotor/wings is operated in coordination with said second group of rotor/wings, in order to reduce the destabilizing forces on said fuselage, resulting due to said transition mode.

2. An aircraft having a first flight mode, a transition flight mode and a second flight mode comprising:
a fuselage;
a first rotor/wing;
a second rotor/wing;
at least one propulsion unit to provide forward thrust;
at least one engine to power said propulsion unit and said rotor/wings;
wherein said rotor/wings comprising a plurality of wings rotatably mounted to said fuselage;
wherein during said first flight mode, said rotor/wings rotate in counter-rotation to produce vertical lift;
wherein during said second flight mode, said rotor/wings are not rotating and at least one said rotor/wing is positioned to produce aerodynamic lift as fixed wings;
wherein during said transition flight mode when said aircraft is transiting between said first flight mode and said second flight mode, said first rotor/wing is operated in coordination with said second rotor/wings, in order to reduce the destabilizing effect on said fuselage, resulting due to said transition mode.

3. An aircraft as recited in claim 2, wherein said first rotor/wing is located above the said fuselage and said second rotor/wing is located under the said fuselage.

4. An aircraft as recited in claim 3, wherein said first rotor/wing and said second rotor/wing are coaxial relative to each other.

5. An aircraft as recited in claim 3, wherein at least one of the mast fairing enclosing the transmission shaft of the said rotor/wing comprises the vertical stabiliser.

6. An aircraft as recited in claim 3, comprising a canard wing coupled to said fuselage.

7. An aircraft as recited in claim 3, wherein at least one of said rotor/wing may be folded during said second flight mode so as to operate as a vertical stabiliser.

8. An aircraft as recited in claim 3, wherein during said second flight mode at least one said rotor/wing may be rotated in a plurality of swept orientations relative to said fuselage which permit flight at relatively higher velocities.

9. An aircraft as recited in claim 4, wherein during said second flight mode said rotor/wings may be rotated to a plurality of orientations, ranging from a position laterally traverse to said fuselage to a swept orientation which permit flight at relatively higher velocities.

10. An aircraft as recited in claim 4, wherein during said second flight mode, said first rotor/wing is folded upward in a dihedral configuration and said second rotor/wing is folded downward in an anhedral configuration.

11. An aircraft as recited in claim 3, further comprises a landing gear located under said second rotor/wing, and is couple to said fuselage by means of a connecting element passing through the hollow transmission shaft of said rotor/wing.

12. An aircraft as recited in claim 1; further comprising at least one set of fixed wings coupled to said fuselage to produce aerodynamic lift during said second flight mode.

13. An aircraft having a first flight mode, a transition flight mode and a second flight mode comprising:
a fuselage;
at least one set of coaxial rotor/wings at the forward end of said fuselage;
at least one set of coaxial rotor/wings at aft end of said fuselage;
at least one propulsion unit to provide forward thrust;
at least one engine to power said propulsion unit and said set of coaxial rotor/wings;
wherein said set of coaxial rotor/wings comprising a first and a second rotor/wings on the same vertical axis which rotate coaxially to produce vertical lift during the said first flight mode, said first rotor/wing rotatably mounted above said fuselage and said second rotor/wing rotatably mounted below said fuselage, and said rotor/wings comprising of a plurality of wings;
wherein during said first flight mode, said sets of coaxial rotor/wings produce vertical lift;
wherein during said second flight mode, said coaxial rotor/wings are not rotating and at least one said rotor/wing is positioned to produce aerodynamic lift as fixed wings;
wherein during said transition flight mode when said aircraft is transiting between said first flight mode and said second flight mode, said first rotor/wing is operated in coordination with said second rotor/wing in order to reduce the destabilizing forces on said fuselage, resulting due to the said transition mode.

14. An aircraft as recited in claim 13, further comprising of at least one set of auxiliary fixed wings coupled to said fuselage.

15. An aircraft as recited in claim 14, wherein said rotor/wings are oriented generally laterally traverse to said fuselage, said rotor/wings producing aerodynamic lift as fixed wings at least to maintain the longitudinal stability of said aircraft.

16. An aircraft as recited in claim 13, wherein during said transition mode said set of coaxial rotor/wings are operated simultaneously or sequentially.

17. An aircraft as recited in claim 14, wherein during said transition mode said coaxial rotor/wings are operated simultaneously or sequentially.

18. An aircraft as recited in claim 13, further comprises at least one landing gear located under said second rotor/wing and is couple to said fuselage by means of a connecting element passing through the hollow transmission shaft of said second rotor/wing.

19. An aircraft as recited in claim 14, further comprises at least one landing gear located under said second rotor/wing and is couple to said fuselage by means of a connecting element passing through the hollow transmission shaft of said second rotor/wing.
